(19) United States
(12) Patent Application Publication
(10) Pub. No.: US 2014/0186671 A1
(43) Pub. Date: Jul. 3, 2014

(54) SECONDARY CELL

(71) Applicant: MPLUS CORP., Chungcheongbukdo (KR)

(72) Inventors: Jong Sung KIM, Gyeonggido (KR); Joon Yong PARK, Chungcheongbukdo (KR)

(73) Assignee: MPLUS CORP., Chungcheongbukdo (KR)

(21) Appl. No.: 14/196,020

(22) Filed: Mar. 4, 2014

Related U.S. Application Data
(62) Division of application No. 13/131,325, filed on May 26, 2011.

(30) Foreign Application Priority Data
Nov. 27, 2008 (KR) 10-2008-0118753
Sep. 15, 2009 (KR) 10-2009-0087164

(51) Int. Cl. H01M 10/04

(52) U.S. Cl. CPC H01M 10/0431
USPC 429/94

(57) ABSTRACT

The present invention provides a method for manufacturing a secondary cell, comprising the steps of: disposing two sheets of separators (10) above and below a negative electrode plate (30), disposing a positive electrode plate (40) above the upper separator (10) or below the lower separator (10), and supplying elongated each one end of the separators (10), the negative electrode plate (30), and the positive electrode plate (40) to a mandrel (20) along the same transfer line; punching each vertical one end and/or the other end of the negative electrode plate (30) and the positive electrode plate (40), which intersects the transfer direction of the negative electrode plate (30) and the positive electrode plate (40) continuously supplied, to form a plurality of negative electrode tabs (32) on the negative electrode plate (30) by a predetermined gap (g) and form a plurality of positive electrode tabs (42) on the positive electrode plate (40) by a predetermined gap (g); winding the stacked body (S) of the separator/negative electrode plate/separator/positive electrode plate altogether by the mandrel (20) to produce an electrode assembly (50) having one side on which the plurality of negative electrode tabs (32) and the positive electrode tabs (42) are stacked; separating the mandrel (20) from the electrode assembly (50), and transferring the electrode assembly (50) by a holding unit; and cutting the separator/negative electrode plate/separator/positive electrode plate connected to the electrode assembly (50) by using a cutting unit. The present invention prevents the positive electrode tabs (42) and the negative electrode tabs (32) stacked into layers from being deviated sideways by the thickness of the electrode when the transfer speeds of the positive electrode tabs (42) and the negative electrode tabs (32) are controlled and the stacked body (S) is wound to form the electrode assembly (50).

### TECHNICAL FIELD

The present invention relates to a method for manufacturing a secondary cell and a secondary cell manufactured thereby, and more particularly to a method for manufacturing a secondary cell and a secondary cell manufactured thereby which simplify a manufacturing process of the secondary cell so as to advantageously enable rapid mass production, are expected to result in improvement in safety of the cell and improvement in performance of the cell, and particularly achieve a high charge/discharge rate using multi-tab parts of respective electrode plates.

### BACKGROUND ART

Devices to store and supply electric power have been used for a long time. Cells mean devices including electro-chemical cells to supply electric potential between at least one set of terminals and a group of the cells. Terminals of a cell are electrically connected to, for example, a DC load, and supply energy, i.e., voltage, to the load. Cells include dry batteries, galvanic batteries (for example, a lead-acid battery) and other devices, which generally convert chemically usable electromotive force into current.

Among these cells, a secondary cell is manufactured using an electrode assembly having a three layer structure of a positive electrode plate/separator/negative electrode plate configuration or a five layer structure of a positive electrode plate/separator/negative electrode plate/separator/positive electrode plate configuration. Such a secondary cell is “rechargeable” after use, and, although the capacity of the cell is not infinite, the discharge treatment of the cell is inversely performed to some degree, and thus the cell may be repeatedly used.

Among conventional methods for designing secondary cells, there is a method for manufacturing a secondary cell in which a separator is supplied from one side and a unit cell (a cell provided with a positive electrode plate having positive electrode tabs and a negative electrode plate having negative electrode tabs) is periodically supplied from the other side. Such a secondary cell manufacturing method has drawbacks, such as a difficulty in mass production due to low productivity caused by a large number of processes, harmful influence on cell safety due to foreign substances (particles, etc.) generated by cutting of a cell side surface, and a difficulty in achieving high yield.

Further, the conventional secondary cell designing methods employ welding between electrode plates, in other words, a positive electrode plate and a negative electrode plate, during stacking of the electrode plates and thus have a drawback, such as a difficulty in accurate adjustment of a step difference (deviation) between a positive electrode and a negative electrode, and being undesirable in terms of cell reliability and safety.

### DISCLOSURE

### Technical Problem

Therefore, the present invention has been made in view of the above problems, and it is an object of the present invention to provide a novel method for manufacturing a secondary cell and a secondary cell manufactured thereby which simplify a manufacturing process of the secondary cell so as to advantageously enable rapid mass production and are expected to result in improvement in safety of the cell and improvement in performance of the cell.

It is another object of the present invention to provide a method for manufacturing a secondary cell and a secondary cell manufactured thereby which prevent a step difference between a positive electrode and a negative electrode (for example, deviation of the positive electrode and the negative electrode from original positions) and prevent fatal cell safety defects due to foreign substances (particles) and burrs generated when cutting the electrodes, to improve reliability of the cell.

### Technical Solution

In accordance with an aspect of the present invention, the above and other objects can be accomplished by the provision of a method for manufacturing a secondary cell including disposing two sheets of separators 10 above and below a negative electrode plate 30, disposing a positive electrode plate 40 above the upper separator 10 or below the lower separator 10 and continuously supplying one end of each of the separator/negative electrode plate/separator/positive electrode plate to a mandrel 20 along a transfer line, punching one vertical side and/or the other vertical side of each of the negative electrode plate 30 and the positive electrode plate 40, which intersects a transfer direction of the negative electrode plate 30 and the positive electrode plate 40, to form a plurality of negative electrode tabs 32 on the negative electrode plate 30 by a predetermined gap g and to form a plurality of positive electrode tabs 42 on the positive electrode plate 40 by a predetermined gap g, winding the stacked body S of the separator/negative electrode plate/separator/positive electrode plate by the mandrel 20 to form an electrode assembly 50 having one side on which the plurality of negative electrode tabs 32 and the plurality of positive electrode tabs 42 are stacked, separating the mandrel 20 from the electrode assembly 50 and transferring the electrode assembly 50 using a holding unit, and cutting the separator/negative electrode plate/separator/positive electrode plate connected to the electrode assembly 50 using a cutting unit.

One vertical side of the negative electrode plate 30 and one vertical side of the positive electrode plate 40 may be intermittently punched to form the plurality of negative electrode tabs 32 on the negative electrode plate 30 by the predetermined gap g and to form the plurality of positive electrode tabs 42 on the positive electrode plate 40 by the predetermined gap g, thereby allowing both the plurality of negative electrode tabs 32 and the plurality of positive electrode tabs 42 to be provided on one vertical side of the electrode assembly 50.

One vertical side of the negative electrode plate 30 may be intermittently punched to form the plurality of negative electrode tabs 32 on the vertical side of the negative electrode plate 30, and the plurality of positive electrode tabs 42 may be formed on one vertical side of the positive electrode plate 40 opposite to the plurality of negative electrode tabs 32 of the negative electrode plate 30 by the predetermined gap g, thereby allowing the plurality of negative electrode tabs 32 and the plurality of positive electrode tabs 42 to be provided on both vertical sides of the electrode assembly 50.

In accordance with another aspect of the present invention, there is provided a method for manufacturing a secondary cell including disposing two sheets of separators 10 above and below a negative electrode plate 30, disposing a positive electrode plate 40 above the upper separator 10 or below the lower separator 10, and continuously supplying one end of each of the separator/the negative electrode plate/separator/positive electrode plate to a mandrel 20 along a transfer line, winding the stacked body S of the separator/negative electrode plate/separator/positive electrode plate, continuously supplied, by the mandrel 20 to form an electrode assembly 50 having both vertical sides on which a plurality of negative electrode tabs 32 and a plurality of positive electrode tabs 42 are stacked, separating the mandrel 20 from the electrode assembly 50 and transferring the electrode assembly 50 using a holding unit, and cutting the separator/negative electrode plate/separator/positive electrode plate connected to the electrode assembly 50 using a cutting unit.

The method may further include cutting edges of both horizontal ends of the plurality of negative electrode tabs 32 and the plurality of positive electrode tabs 42 of the electrode assembly 50 to form edge cutting parts 57 at the plurality of negative electrode tabs 32 and the plurality of positive electrode tabs 42, and respectively bonding a positive electrode lead terminal 44 and a negative electrode lead terminal 34 to the plurality of positive electrode tabs 42 and the plurality of negative electrode tabs 32.

The method may further include attaching a separate TAB tape 70 to the positive electrode lead terminal 44 and the negative electrode lead terminal 34 respectively bonded to the plurality of positive electrode tabs 42 and the plurality of negative electrode tabs 32, and sealing the electrode assembly 50 in a state, in which the positive electrode lead terminal 44 and the negative electrode lead terminal 34 are respectively bonded to the plurality of positive electrode tabs 42 and the plurality of negative electrode tabs 32, by a pouch 90, and the pouch 90 may be sealed by joining the positive electrode lead terminal 44 and the negative electrode lead terminal 34 and the pouch 90 to each other by fusion via the TAB tape 70.

The sealing of the pouch 90 by fusion to keep the electrode assembly 50 airtight may be performed after a separate protective tape 80 is attached to a bonding area between the plurality of positive electrode tabs 42 and the positive electrode lead terminal 44 and a bonding area between the plurality of negative electrode tabs 32 and the negative electrode lead terminal 34 so as to cover the bonding areas.

### Advantageous Effects

The present invention provides a method for manufacturing a secondary cell in which an electrode assembly is formed by forming a plurality of positive electrode tabs and a plurality of negative electrode tabs by punching a positive electrode plate and a negative electrode plate while supplying the separator/negative electrode plate/separator/positive electrode plate along a transfer line and then by winding the stacked body of the separator/negative electrode plate/separator/positive electrode plate using a mandrel. The method enables a large number of electrode assemblies to be rapidly formed through a continuous process, thereby simplifying a manufacturing process compared to the conventional stack type secondary cell manufacturing process, and thus advantageously enabling rapid mass production and improving safety in manufacturing the cell.

Further, the manufactured secondary cell in the wound type reduces interface resistance between the electrodes to achieve stabilization in cell characteristic dispersion, and prevents generation of foreign substances (particles, etc.) and burrs due to electrode cutting so as to greatly contribute to cell safety and assembly yield.

Further, each of a positive electrode tab part and a negative electrode tab part consists of multi-tabs to improve electrical mobility, thereby improving performance of the cell so as to allow the cell serving as a high-rate cell and not being greatly influenced by deviation of the positive electrode tab part and the negative electrode tab part.

In accordance with one embodiment of the present invention, when the electrode assembly is formed by supplying the stacked body of the positive electrode plate/separator/negative electrode plate/separator along the transfer line and winding the stacked body without the punching process, the positive electrode tabs and negative electrode tabs are provided on both sides of the electrode assembly in the vertical direction (i.e., the direction perpendicular to the direction of continuously supplying and winding the stacked body of the positive electrode plate/separator/negative electrode plate/separator). Such an embodiment in which the positive electrode tabs and the negative electrode tabs are respectively provided on both vertical sides of the cell also has effects which are the same as or similar to the above effects.

In the case of the embodiment in which the positive electrode tabs and the negative electrode tabs are respectively provided on both vertical sides of the cell, the TAB tape attached to the negative electrode lead terminal and the positive electrode lead terminal needs to have a size greater than that of the negative and positive electrode lead terminals, and thus the manufactured cell is much larger than the stacked body, thereby lowering energy efficiency per unit area. Therefore, in order to reduce the size of the stacked body to which the lead terminals are attached below the cell size of the negative electrode plate and the positive electrode plate to decrease an unnecessary space, the edges of both horizontal ends of the negative electrode tabs and the positive electrode tabs of the electrode assembly are cut to form edge cutting parts, and such edge cutting parts cause increase in energy efficiency of the manufactured cell per unit area.

### DESCRIPTION OF DRAWINGS

The above and other objects, features and other advantages of the present invention will be more clearly understood from the following detailed description taken in conjunction with the accompanying drawings, in which:

FIG. 1 is a side view schematically illustrating a method for manufacturing a secondary cell in accordance with the present invention;

FIG. 2 is a plan view illustrating a process of forming negative electrode tabs on a negative electrode plate and a process of forming positive electrode tabs on a positive electrode plate shown in FIG. 1;

FIG. 3 is a front view illustrating usage of a mandrel employed in the present invention;

FIG. 4 is a plan view of the mandrel shown in FIG. 3;

FIG. 5 is a plan view of a secondary cell manufactured in accordance with the present invention;

FIG. 6 is a cross-sectional view of FIG. 5;

FIG. 7 is a view illustrating a process of welding a positive electrode lead terminal and a negative electrode lead terminal to positive electrode tabs and negative electrode tabs of an electrode assembly shown in FIG. 5;

FIG. 8 is a plan view illustrating a process of forming negative electrode tabs on a negative electrode plate and a process of forming positive electrode tabs on a positive electrode plate in accordance with another embodiment of the present invention;

FIG. 9 is a view illustrating a process of welding a positive electrode lead and a negative electrode lead to the positive electrode tabs and the negative electrode tabs of the secondary cell in accordance with the embodiment of the present invention without deviation due to thicknesses of electrodes during winding;

FIG. 10 is a perspective view illustrating a secondary cell manufactured in accordance with a first embodiment of the present invention;

FIGS. 11 and 12 are views illustrating separators, a negative electrode plate and a positive electrode plate supplied to form an electrode assembly in accordance with a second embodiment of the present invention;

FIG. 13 is a plan view illustrating the electrode assembly manufactured through a winding method in accordance with the second embodiment of the present invention;

FIG. 14 is a plan view illustrating bonding of a positive electrode lead terminal and a negative electrode lead terminal to positive electrode tabs and negative electrode tabs of the electrode assembly shown in FIG. 13;

FIGS. 15 and 16 are views illustrating separators, a negative electrode plate and a positive electrode plate supplied to form an electrode assembly in accordance with a third embodiment of the present invention;

FIG. 17 is a plan view illustrating the electrode assembly manufactured through a winding method in accordance with the third embodiment of the present invention;

FIG. 18 is a plan view illustrating formation of edge cutting parts on positive electrode tabs and negative electrode tabs of the electrode assembly shown in FIG. 17;

FIG. 19 is a plan view illustrating bonding of a positive electrode lead terminal and a negative electrode lead terminal to the positive electrode tabs and the negative electrode tabs of the electrode assembly shown in FIG. 18;

FIG. 20 is a plan view illustrating formation of edge cutting parts having another shape on the positive electrode tabs and the negative electrode tabs of the electrode assembly shown in FIG. 17;

FIG. 21 is a plan view illustrating bonding of a positive electrode lead terminal and a negative electrode lead terminal to the positive electrode tabs and the negative electrode tabs of the electrode assembly shown in FIG. 20;

FIG. 22 is a plan view conceptually illustrating bonding of a positive electrode lead terminal and a negative electrode lead terminal to positive electrode tabs and negative electrode tabs of an electrode assembly in accordance with one embodiment of the present invention; and

FIG. 23 is a plan view illustrating attachment of a protective tape to the positive electrode tabs and the negative electrode tabs of the electrode assembly shown in FIG. 22.

### BEST MODE

The present invention provides a method for manufacturing a secondary cell including disposing two sheets of separators 10 above and below a negative electrode plate 30, disposing a positive electrode plate 40 above the upper separator 10 or below the lower separator 10 and continuously supplying one end of each of the separator/negative electrode plate/separator/positive electrode plate to a mandrel 20 along a transfer line, punching one vertical side and/or the other vertical side of each of the negative electrode plate 30 and the positive electrode plate 40, which intersects to a transfer direction of the negative electrode plate 30 and the positive electrode plate 40, to form a plurality of negative electrode tabs 32 on the negative electrode plate 30 by a predetermined gap g and to form a plurality of positive electrode tabs 42 on the positive electrode plate 40 by a predetermined gap g, winding the stacked body S of the separator/negative electrode plate/separator/positive electrode plate by the mandrel 20 to form an electrode assembly 50 having one side on which the plurality of negative electrode tabs 32 and the plurality of positive electrode tabs 42 are stacked, separating the mandrel 20 from the electrode assembly 50 and transferring the electrode assembly 50 using a holding unit, and cutting the separator/negative electrode plate/separator/positive electrode plate connected to the electrode assembly 50 using a cutting unit.

### MODE FOR INVENTION

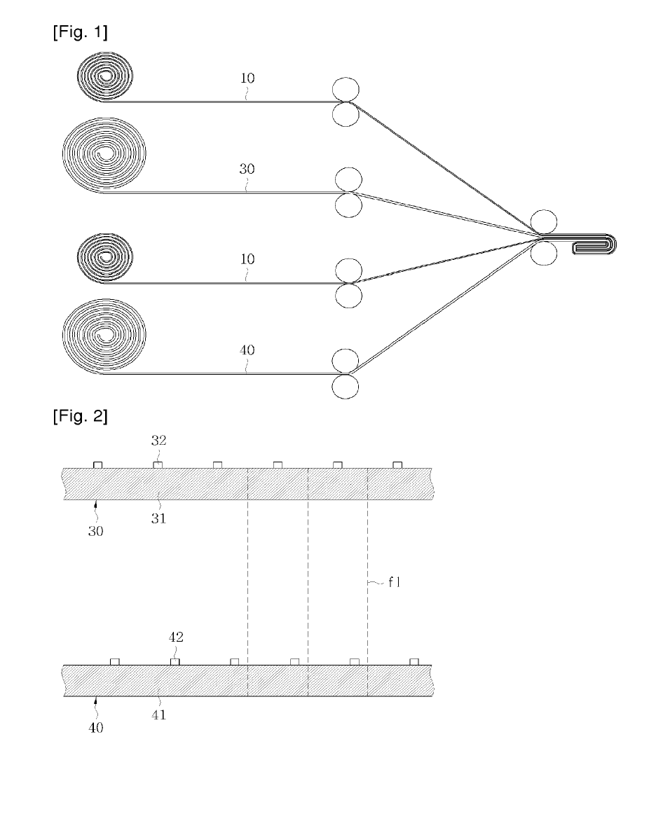

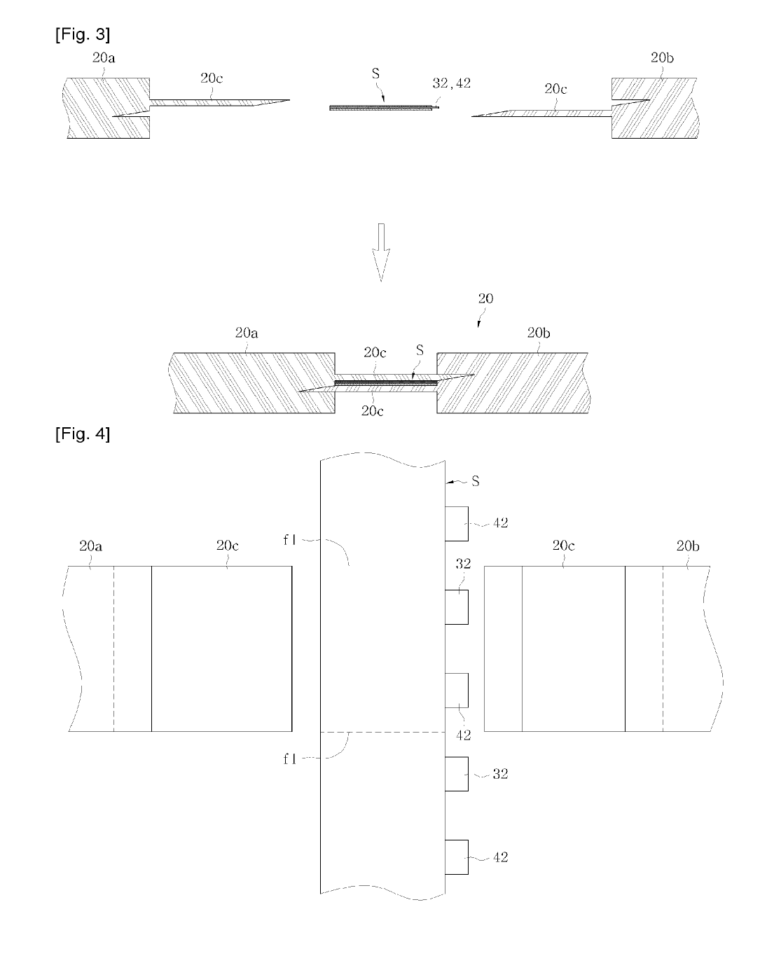

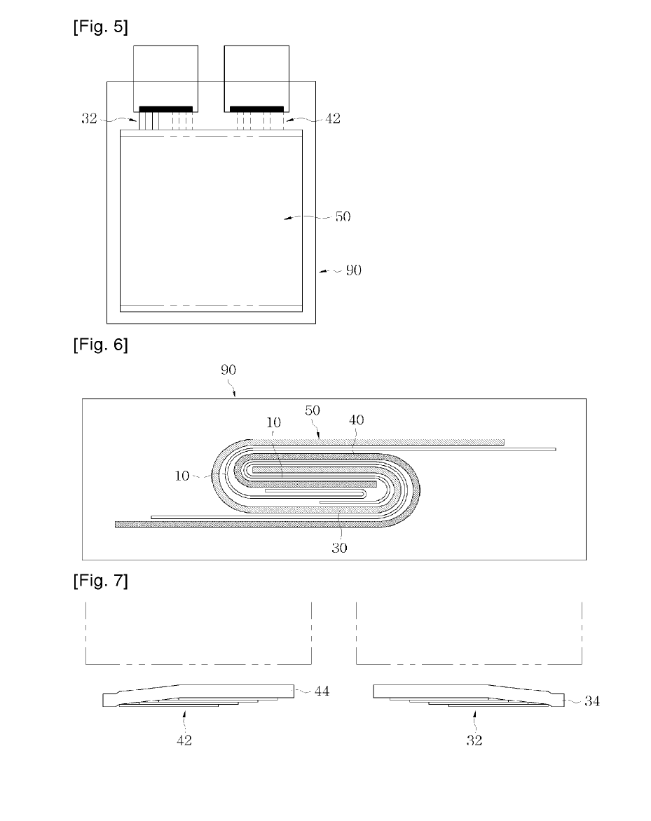

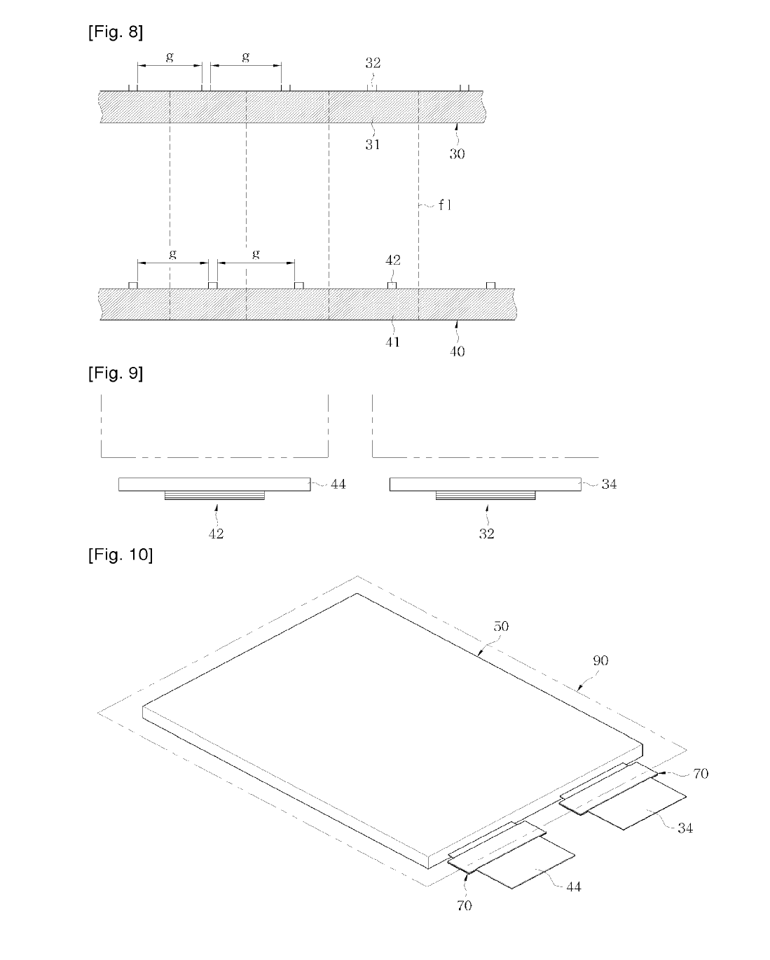

Hereinafter, preferred embodiments of the present invention will be described in detail with reference to the annexed drawings. FIG. 1 is a side view schematically illustrating a method for manufacturing a secondary cell in accordance with the present invention, FIG. 2 is a plan view illustrating a process of forming negative electrode tabs on a negative electrode plate and a process of forming positive electrode tabs on a positive electrode plate shown in FIG. 1, FIG. 3 is a front view illustrating usage of a mandrel employed in the present invention, FIG. 4 is a plan view of the mandrel shown in FIG. 3, FIG. 5 is a plan view of a secondary cell manufactured in accordance with the present invention, FIG. 6 is a cross-sectional view of FIG. 5, FIG. 7 is a view illustrating a process of welding a positive electrode lead terminal and a negative electrode lead terminal to positive electrode tabs and negative electrode tabs of an electrode assembly shown in FIG. 5, FIG. 8 is a plan view illustrating a process of forming negative electrode tabs on a negative electrode plate and a process of forming positive electrode tabs on a positive electrode plate in accordance with another embodiment of the present invention, FIG. 9 is a view illustrating a process of welding a positive electrode lead and a negative electrode lead to the positive electrode tabs and the negative electrode tabs of the secondary cell in accordance with the embodiment of the present invention without deviation due to thicknesses of electrodes during winding, and FIG. 10 is a perspective view illustrating a secondary cell manufactured in accordance with a first embodiment of the present invention. With reference to FIGS. 1 to 10, feed rolls sequentially disposed from the top continuously supply an uppermost positive electrode plate 40, a separator 10, a negative electrode plate 30 disposed below the separator 10, and another separator 10 disposed below the negative electrode plate 30 to a mandrel 20 along the same transfer line. Here, the respective separators 10, the negative electrode plate 30 and the positive electrode plate 40 may be continuously supplied along the transfer line by a feed guider, such as a separate guide roll. The negative electrode plate 30 has a structure divided into a coated surface 31, which is coated with an electrolyte material (an active material), and a non-coated surface 33 (i.e., a surface which is not coated with an electrolyte material (an active material)) provided on the surface located at one side of the negative electrode plate 30 in the vertical direction (here, the vertical direction meaning a direction perpendicular to a transfer direction of the negative electrode plate 30), the positive electrode plate 30 also has a structure divided into a coated surface 41 and a non-coated surface 43, and a width of each of the respective separators 10 in the vertical direction (i.e., in a direction perpendicular to the transfer direction) is greater than those of the coated surface 41 of the positive electrode plate 40 and the coated surface 31 of the negative electrode plate 30 by a designated length (generally, greater than that of the negative electrode plate 30 by 0.5 mm˜4.0 mm).

A plurality of negative electrode tabs 32 is formed on one side of the negative electrode plate 30 in the vertical direction by a regular gap g by respectively punching the non-coated surface 33 of the negative electrode plate 30, continuously supplied, provided at the side of the negative electrode plate 30 in the vertical direction (i.e., the direction perpendicular to the horizontal direction in which the negative electrode plate 30 is transferred) using a punching unit, and a plurality of positive electrode tabs 42 is formed on one side of the positive electrode plate 40 in the vertical direction by a regular gap g by punching the non-coated surface 43 of the positive electrode plate 40, continuously supplied, provided on the side of the positive electrode plate 40 in the vertical direction (i.e., the direction perpendicular to the horizontal direction in which the positive electrode plate 40 is transferred) using the punching unit. Here, as shown in FIG. 2, the negative electrode tabs 32 of the negative electrode plate 30 and the positive electrode tabs 42 of the positive electrode plate 40 are formed by punching one side of the negative electrode plate 30 and one side of the positive electrode plate 40 using the punching unit so that the negative electrode tabs 32 and the positive electrode tabs 42 are arranged at alternate positions in the vertical direction perpendicular to the horizontal transfer direction. Thereby, the negative electrode tabs 32 and the positive electrode tabs 42 may be arranged in parallel without overlap therebetween when an electrode assembly 50 which will be described later is formed. Folding lines f1 shown in FIG. 2 mean lines which are folded when the electrode assembly 0 is formed through a process of winding a stacked body S which will be described later (a winding process).

Thereafter, the stacked body S of the separator/negative electrode plate/separator/positive electrode plate is wound using the mandrel 20, thereby forming the electrode assembly 50 provided with one side on which the positive electrode tabs 42 and the negative electrode tabs 32 are stacked. That is, the electrode assembly 50 in which plural layers of the positive electrode plate 40 and the negative electrode plate 30 are stacked between plural layers of the separators 10 and both the positive electrode tabs 42 and the negative electrode tabs 32 are provided on one side of the electrode assembly 50 may be formed.

The mandrel 20 is separated from the electrode assembly 50 and is drawn in the opposite direction to the transfer direction, and the electrode assembly 50 is continuously transferred along the transfer line using a holding unit. Of course, the stacked body S of the separator/negative electrode plate/separator/positive electrode plate is connected to the electrode assembly 50.

Thereafter, the mandrel 20 enters the part of the stacked body S connected to the electrode assembly 50 and thus grips the separator/negative electrode plate/separator/positive electrode plate, and a cutting unit, such as cutters, disposed at the next portion of the mandrel 20 cut the separator/negative electrode plate/separator/positive electrode plate, thereby manufacturing a separate electrode assembly 50.

Mass production of electrode assemblies 50 each of which has a structure, in which plural layers of the positive electrode plate 40 and the negative electrode plate 30 are stacked between plural layers of the separators 10 and both the positive electrode tabs 42 and the negative electrode tabs 32 are provided on one side of each electrode assembly 50, may be achieved by repeating the above process.

The mandrel employed in the present invention includes a pair of mandrel members movable forward and backward, and holding members protruded from surfaces of the pair of mandrel members, which are opposite to each other. As shown in FIG. 3, the mandrel is rotated to wind the stacked body S under the condition that the pair of mandrel members having moved backward moves forward and then the holding members grip the stacked body S, thereby forming the electrode assembly 50.

After the electrode assembly 50 is formed through the above winding method, the positive electrode tabs 42 and the negative electrode tabs 32 of the electrode assembly 50 are respectively welded so as to be respectively bonded, and then ends of the tabs 32 and 42 are trimmed so as to have the same distance.

After the positive electrode tabs 42 and the negative electrode tabs 32 of the electrode assembly 50 are respectively welded, a positive electrode lead terminal 44 and a negative electrode lead terminal 34 are respectively bonded to the positive electrode tabs 42 and the negative electrode tabs 32 by welding. Here, a general device, such as an ultrasonic fusion apparatus, may be used.

Then, the electrode assembly 50 in which the positive electrode lead terminal 44 and the negative electrode lead terminal 34 are respectively welded to the positive electrode tabs 42 and the negative electrode tabs 32 is sealed by a pouch 90. Here, a TAB tape 70 for fusion is first attached to the positive electrode lead terminal 44 and the negative electrode lead terminal 34, and the electrode assembly 50 is then sealed by the pouch 90.

In other words, the electrode assembly 50 is inserted into the pouch 90 so that both surfaces of the electrode assembly 50 are covered by the pouch 90, and from among four edges of the pouch 90, i.e., upper, lower, left and right edges, the upper and lower edges and the left or right edge are first sealed by fusion using a hot sealing method.

Then, the left or right edge of the pouch 90 is sealed, and parts of the upper edge of the pouch 90 opposite to the positive electrode lead terminal 44 and the negative electrode lead terminal 34 are integrally joined to the positive electrode lead terminal 44 and the negative electrode lead terminal 34 by the TAB tape 70 attached in advance to the positive electrode lead terminal 44 and the negative electrode lead terminal 34, and thus are sealed. That is, the pouch 90 may be more firmly fused to the positive electrode lead terminal 44 and the negative electrode lead terminal 34 via the TAB tape 70, thereby more increasing sealability between the positive and negative electrode lead terminals 34 and the pouch 90.

One edge of the pouch 90 forming the secondary cell in accordance with the present invention is not sealed, an electrolyte is injected into the pouch 90 through an opening formed on the edge, charge/discharge of the secondary cell is completed, the inside of the secondary cell is degassed, an extra part of the edge of the pouch 90 is cut off, and then the remaining part of the edge of the pouch 90 is sealed. During charge/discharge of the secondary cell, gas is generated and fills the inside of the pouch 90 and thus the pouch 90 is inflated. When gas fills the inner space of the pouch 90, gas filling the inside of the pouch 90 is removed by degassing, the extra part of the edge of the pouch 90 is cut off, and then the remaining opening of the edge of the pouch 90 is sealed through the hot sealing method.

At this time, as shown in FIG. 23, before the pouch 90 is sealed by fusion, a separate protective tape 80 is attached to a bonding area between the positive electrode tabs 42 and the positive electrode lead terminal 44 and a bonding area between the negative electrode tabs 32 and the negative electrode lead terminal 34 so as to protect the bonding areas, and a process of sealing the pouch 90 by fusion so as to keep the electrode assembly 50 airtight is performed.

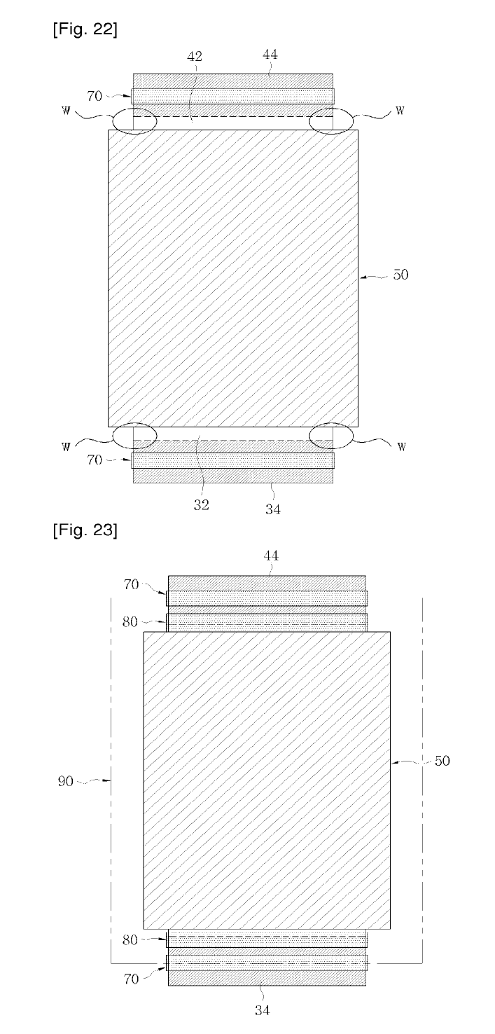

When edge cutting is performed on the non-coated surfaces 33 and 43 of the respective electrode plates 30 and 40, as shown in FIG. 18 or 20, burrs may occur at edge cutting parts 57. Further, buns may occur at welding parts W (shown in FIG. 22) due to welding between the non-coated surfaces 33 and 43 and tabs 32 and 42, and the lead terminals 34 and 44. These buns cause shorts or corrosion due to interaction with an aluminum layer within the pouch 90, and the protective tape 80 prevents such shorts or corrosion.

Corrosion due to interaction with the aluminum layer of the pouch 90 is generated when burrs have the same potential as tabs having a negative electrode potential. However, in the present invention, the protective tape 80 is further provided, and thus prevents generation of shorts or corrosion. Thereby, effects, such as reliability improvement in the cell, may be obtained.

Although this embodiment illustrates that respective punching holes formed by punching one side of the negative electrode plate 30 and one side of the positive electrode plate 40 have a rectangular shape and thus the negative electrode tabs 32 of the negative electrode plate 30 and the positive electrode tabs 42 of the positive electrode plate 40 are formed in a rectangular terminal shape, the negative electrode tabs 32 and the positive electrode tabs 42 may be formed in a diamond shape. In addition, the negative electrode tabs 32 and the positive electrode tabs 42 may be formed in various shapes according to circumferences.

FIGS. 8 and 9 illustrate another embodiment of the present invention. As shown in FIGS. 8 and 9, a gap g between punching holes formed on one side of a negative electrode plate 30 and a gap g between punching holes formed on one side of a positive electrode plate 40 is gradually increased in a transfer direction so that a distance between negative electrode tabs 32 and a distance between positive electrode tabs 42 are gradually increased, and a stacked body S of the separator/negative electrode plate/separator/positive electrode plate is wound to form an electrode assembly 50 having one side on which the plurality of negative electrode tabs 32 and the plurality of positive electrode tabs 42 are stacked.

Here, a transfer speed of the positive electrode plate 40 and the negative electrode plate 30 supplied to the punching device is gradually increased, thereby gradually increasing the gap g between the punching holes formed on one side of the negative electrode plate 30 and the gap g between the punching holes formed on one side of the positive electrode plate 40 and thus gradually increasing the distance between the negative electrode tabs 32 and the distance between the positive electrode tabs 42. Therefore, deviation of the positions of the tabs 32 and 42 by thicknesses of negative/positive electrodes and separators during winding may be compensated by adjustment of the transfer speed.

In other words, when the electrode assembly 50 is formed by winding the stacked body S, the thickness of the electrode assembly 50 is gradually increased, and the positive electrode tabs 42 and the negative electrode tabs 32 stacked are deviated sideways little by little as the thickness of the electrode assembly 50 is gradually increased. Therefore, before the winding process to form the electrode assembly 50, the gap g between the respective positive electrode tabs 42 of the positive electrode plate 40 and the gap g between the respective negative electrode tabs 32 of the negative electrode plate 30 are set to be gradually increased, thereby preventing the positive electrode tabs 42 and the negative electrode tabs 32 stacked from being deviated sideways little by little by the thicknesses of the electrodes. That is, the positive electrode tabs 42 and the negative electrode tabs 32 stacked may be correctly arranged without deviation.

FIG. 8 is a view illustrating a state in which the gap g between the respective positive electrode tabs 42 of the positive electrode plate 40 and the gap g between the respective negative electrode tabs 32 of the negative electrode plate 30 are set to be gradually increased before the winding process in consideration of the thickness of the electrode assembly 50, and FIG. 9 is a view illustrating a state in which the respective positive electrode tabs 42 and the respective negative electrode tabs 32 are arranged in a line without sideways deviation when the electrode assembly 50 is formed by the winding process.

In the embodiment shown in FIGS. 8 and 9, since the respective positive electrode tabs 42 and the respective negative electrode tabs 32 are stacked in place without sideways deviation due to the winding process, safety in welding at regions of the positive electrodes tabs 42 and the negative electrode tabs 32 is more firmly assured and thus electrical mobility is more improved.

A secondary cell shown in FIG. 10 is manufactured by the above-described method of the present invention. The secondary cell in accordance with the present invention includes the electrode assembly 50 formed by interposing the separators 10 between the negative electrode plate 30 provided with the plurality of negative electrode tabs 32 provided on one vertical side thereof and the positive electrode plate 40 provided with the plurality of positive electrode tabs 42 provided on one vertical side thereof and then by winding the stacked body, and the negative electrode tabs 32 and the positive electrode tabs 42 provided on one vertical side of the electrode assembly 50 such that the negative electrode lead terminal 34 and the positive electrode lead terminal 44 are respectively bonded to the negative electrode tabs 32 and the positive electrode tabs 42. Such an electrode assembly 50 is sealed by the pouch 90.

The pouch 90 is firmly sealed by fusion via the TAB tape 70 attached to the positive electrode lead terminal 44 and the negative electrode lead terminal 34. Here, as described above, before the pouch 90 is sealed by fusion, the protective tape 80 is attached to the bonding area between the positive electrode tabs 42 and the positive electrode lead terminal 44 and the bonding area between the negative electrode tabs 32 and the negative electrode lead terminal 34 so as to protect the bonding areas, as shown in FIG. 23, thereby more firmly preventing short generation or corrosion generation.

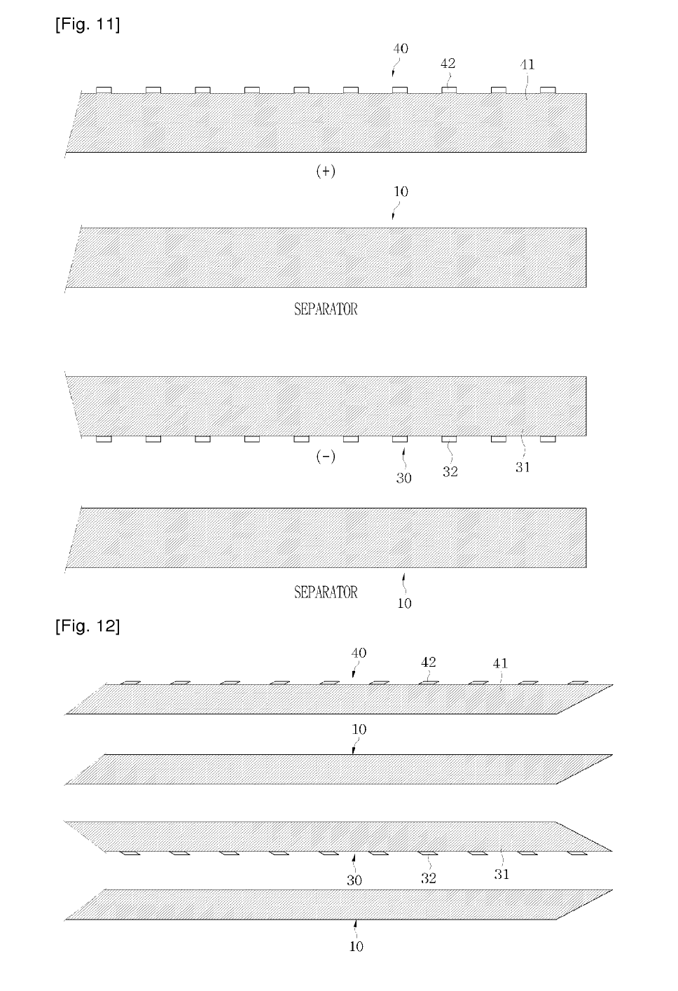

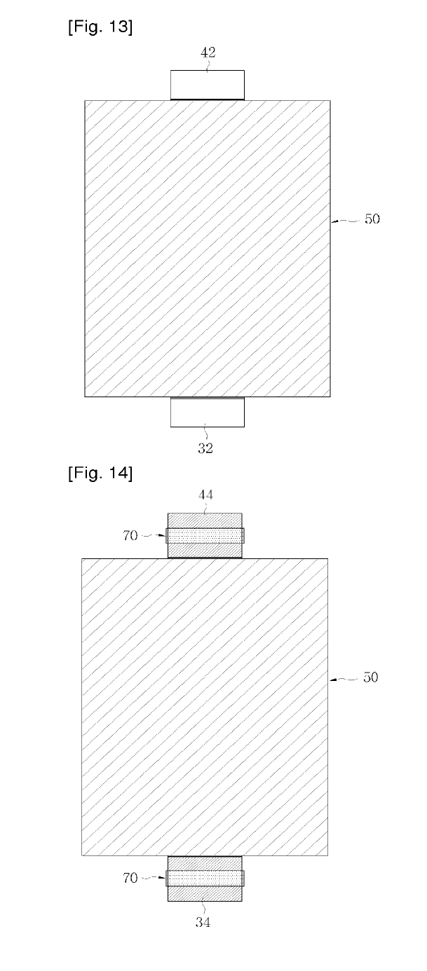

FIGS. 11 to 14 illustrate another embodiment of the present invention. In accordance with the embodiment shown in FIGS. 11 to 14, a plurality of positive electrode tabs 42 and a plurality of negative electrode tabs 32 are formed by punching a non-coated surface 43 of a positive electrode plate 40 and a non-coated surface 33 of a negative electrode plate 30 using a punching unit under the condition that the non-coated surface 43 of the positive electrode plate 40 and the non-coated surface 33 of the negative electrode plate 30 are disposed at opposite positions in the vertical direction, and a stacked body S of the positive electrode plate/separator/negative electrode plate/separator is supplied to a mandrel 20 and then is wound, thereby manufacturing a secondary cell having both vertical sides on which the positive electrode tabs 42 and the negative electrode tabs 32 are respectively provided. Remaining processes are the same as those of the former embodiment, and a detailed description thereof will thus be omitted because it is considered to be unnecessary.

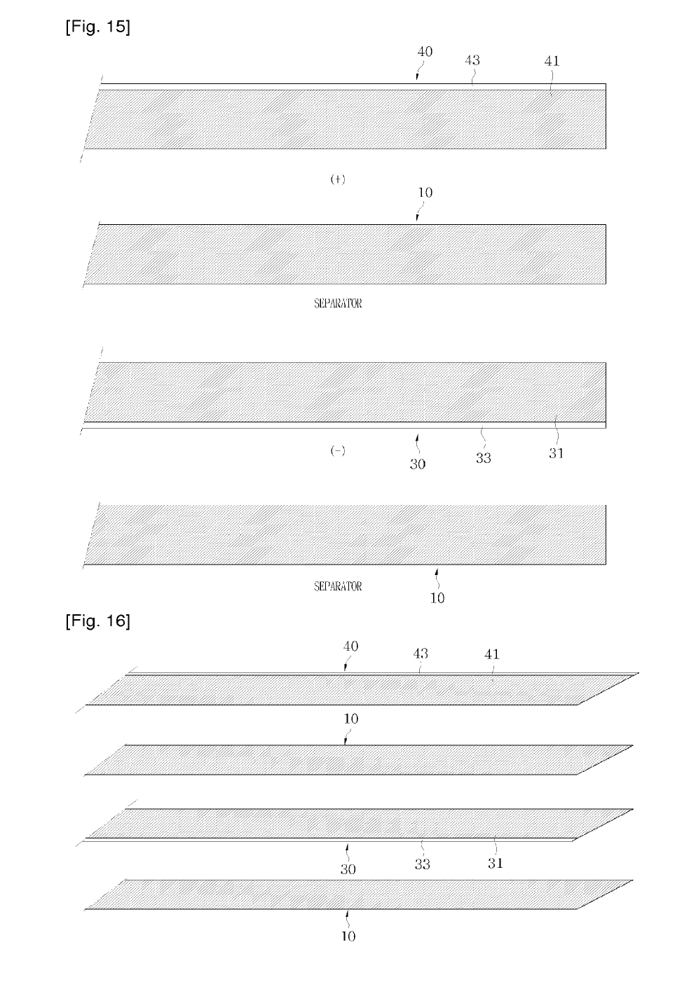

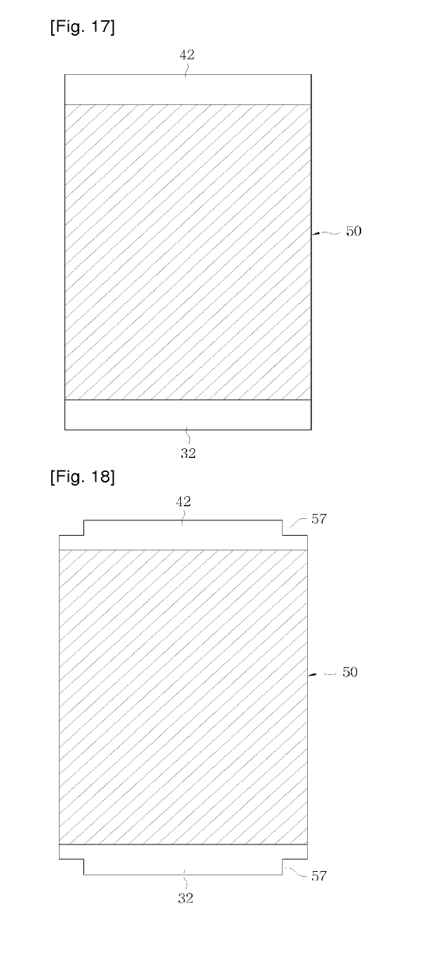

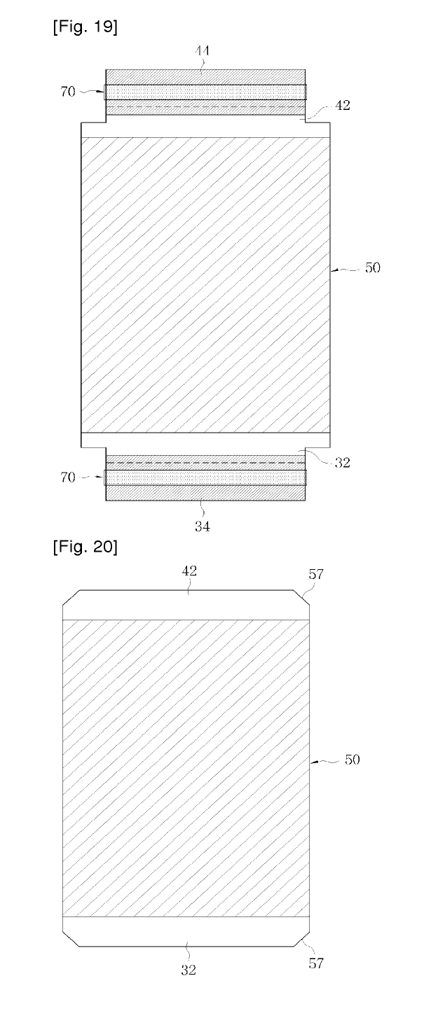

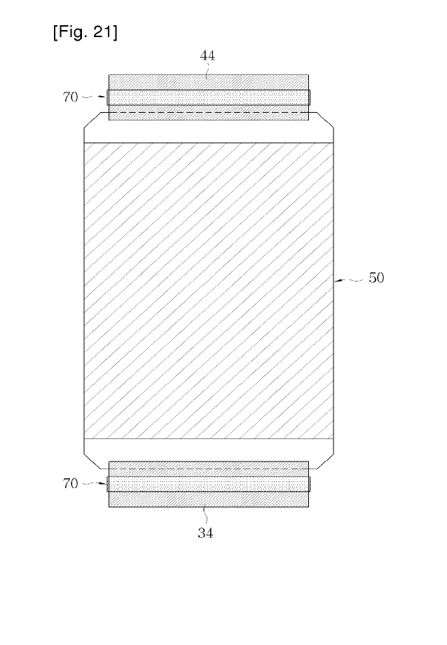

Further, FIGS. 15 to 19 illustrate yet another embodiment of the present invention. In accordance with the embodiment shown in FIGS. 15 to 19, a stacked body S of a positive electrode plate/separator/negative electrode plate/separator configuration is supplied to a mandrel 20 and then is wound without the punching process, thereby manufacturing a secondary cell having both vertical sides on which positive electrode tabs 42 and negative electrode tabs 32 are respectively provided. That is, the stacked body S is wound under the condition that a width of each of the respective separators 10 in the vertical direction is greater than those of electrolyte coated surfaces 31 of a positive electrode plate 40 and a negative electrode plate 30 by a designated length, thereby manufacturing the secondary cell having both vertical sides on which the positive electrode tabs 42 and the negative electrode tabs 32 are respectively provided.

Here, as shown in FIG. 18, edges of both horizontal ends of the negative electrode tabs 32 and the positive electrode tabs 42 of the electrode assembly 50 are cut, thus forming edge cutting parts 57 at the left and right edge parts of the negative electrode tabs 32 and the positive electrode tabs 42.

The edge cutting parts 57 may be formed in a rectangular groove shape, as shown in FIG. 18, or be formed in an inclined shape, as shown in FIG. 20. Otherwise, the edge cutting parts 57 may be formed in various other shapes.

In accordance with each of the above-described embodiments, the secondary cell in which the electrode assembly 50, i.e., a main body of the secondary cell, is formed through the winding method, the positive electrode tabs 42 and the negative electrode tabs 32 are provided on the electrode assembly 50, the positive electrode lead terminal 44 and the negative electrode lead terminal 34 are connected to the positive electrode tabs 42 and the negative electrode tabs 32, and the electrode assembly 50 is sealed by the pouch 90. Further, it is apparent that the TAB tape 70 and the protective tape 80 are provided.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention provides a method for manufacturing a secondary cell and a secondary cell manufactured thereby which simplify a manufacturing process of the secondary cell so as to advantageously enable rapid mass production, are expected to result in improvement in safety of the cell and improvement in performance of the cell, and particularly achieve a high charge/discharge rate using multi-tab parts of respective electrode plates.

1-13. (canceled)

14. A secondary cell comprising:
an electrode assembly in a wound shape formed through a winding process while continuously supplying one end of each of separator/negative electrode plate/separator/positive electrode plate to a mandrel along the same transfer line; and
negative electrode tabs and positive electrode tabs provided on one vertical side and/or the other vertical side of each of the negative electrode plate and the positive electrode plate such that a negative electrode lead terminal and a positive electrode lead terminal are respectively bonded to the negative electrode tabs and the positive electrode tabs,
wherein the negative electrode tabs and the positive electrode tabs are respectively provided on the vertical side and/or the other vertical side of each of the negative electrode plate and the positive electrode plate, which is perpendicular to a transfer direction, by a predetermined gap so that the negative electrode tabs and the positive electrode tabs are respectively stacked on one vertical end and/or the other vertical end of the electrode assembly when the electrode assembly is formed by winding the stacked body.

15. The secondary cell according to claim 14, the electrode assembly has a structure wherein the plurality of negative electrode tabs and the plurality of positive electrode tabs are stacked on one side,
by disposing two sheets of separators above and below a negative electrode plate), disposing a positive electrode plate above the upper separator or below the lower separator, and continuously supplying one end of each of the separator/negative electrode plate/separator/positive electrode plate to a mandrel along a transfer line;
by punching one vertical side and/or the other vertical side of each of the negative electrode plate and the positive electrode plate, which intersects a transfer direction of the negative electrode plate and the positive electrode plate, to form a plurality of negative electrode tabs on the negative electrode plate by a predetermined gap and to form a plurality of positive electrode tabs on the positive electrode plate by a predetermined gap;
and by winding the stacked body of the separator/negative electrode plate/separator/positive electrode plate by the mandrel.

16. The secondary cell according to claim 14, wherein the plurality of negative electrode tabs of the negative electrode plate and the plurality of positive electrode tabs of the positive electrode plate are arranged at alternate positions in the vertical direction perpendicular to the transfer direction.

17. The secondary cell according to claim 14, wherein the plurality of negative electrode tabs of the negative electrode plate and the plurality of positive electrode tabs of the positive electrode plate are respectively arranged on sides, which are opposite to each other in the transfer direction.

18. The secondary cell according to claim 14, further comprising:
a positive electrode lead terminal and a negative electrode lead terminal to the plurality of positive electrode tabs and the plurality of negative electrode tabs by fusion after the plurality of positive electrode tabs and the plurality of negative electrode tabs of the electrode assembly have been trimmed/welded.

19. The secondary cell according to claim 14, wherein the gap between punching holes formed on the negative electrode plate and the gap between the punching holes formed on the positive electrode plate are gradually increased in the transfer direction so that a distance between the plurality of negative electrode tabs and a distance between the plurality of positive electrode tabs are gradually increased, and the stacked body of the separator/negative electrode plate/separator/positive electrode plate is wound to form the electrode assembly having one side and/or the other side on which the plurality of negative electrode tabs and the plurality of positive electrode tabs are stacked.

20. The secondary cell according to claim 14, the electrode assembly forms the body of battery cell by continuously feeding the stacked body wherein the separator/negative electrode plate/separator/positive electrode are stacked and, at the same time, by winding the stacked body, and when the stacked body of the separator/negative electrode plate/separator/positive electrode plate is wound to form the electrode assembly, the electrode assembly has the plurality of negative electrode tabs and the plurality of positive electrode tabs are stacked.

21. The secondary cell according to claim 20, wherein the negative electrode panel has the negative tab on one side and the positive electrode panel has the positive tab on the other side which is opposite side to one side of the negative electrode panel,
wherein the electrode assembly constitutes a body of the cell and formed by winding a stacked body, in which separator/negative electrode plate/separator/positive electrode plate are sequentially disposed, while continuously supplying the stacked body in the horizontal direction; and
wherein the negative electrode tabs and positive electrode tabs respectively are provided on one vertical side and the other vertical side of the electrode assembly When the electrode assembly is formed by winding the stacked body.

22. The secondary cell according to claim 21, further comprising;
edge cutting parts by cutting edges of both horizontal ends of the plurality of negative electrode tabs and the plurality of positive electrode tabs of the electrode assembly to form edge cutting parts at the plurality of negative electrode tabs and the plurality of positive electrode tabs.

23. The secondary cell according to claim 14, further comprising:
a TAB tape attached to a positive electrode lead terminal and a negative electrode lead terminal respectively bonded to the plurality of positive electrode tabs and the plurality of negative electrode tabs;
and a pouch sealing the electrode assembly in a state, in which the positive electrode lead terminal and the negative electrode lead terminal are respectively bonded to the plurality of positive electrode tabs and the plurality of negative electrode tabs,
and wherein the pouch is sealed by joining the positive electrode lead terminal and the negative electrode lead terminal and the pouch to each other by fusion via the TAB tape.

24. The secondary cell according to claim 23, further comprising:
a protective tape attached to a bonding area between the plurality of positive electrode tabs and the positive electrode lead terminal and a bonding area between the plurality of negative electrode tabs and the negative electrode lead terminal so as to cover the bonding areas.
